(19) United States
(12) Patent Application Publication
(10) Pub. No.: US 2006/0133804 A1
(43) Pub. Date: Jun. 22, 2006

(54) Method and apparatus for protecting optical signals within a wavelength division multiplexed environment

(75) Inventors: Mark E. Boduch, Geneva, IL (US); Prem C. Tirilok, Bolingbrook, IL (US)

Correspondence Address: Dean Small;Armstrong Teasdale LLP, Suite 2600, One Metropolitan Square, St. Louis, MO, 63102, US

(73) Assignee: Tellabs Operations, Inc.

(21) Appl. No.: 11/045,674

(22) Filed: Jan. 28, 2005

Related U.S. Application Data
(60) Provisional application No. 60/637,010, filed on Dec. 17, 2004.

(51) Int. Cl. H04B 10/00

(52) U.S. Cl. 398/5

(57) ABSTRACT

A system and method are provided for protecting optical signals within a wavelength division multiplexed (WDM) environment. The system and method utilize a single “protection” wavelength translator device to protect up to N wavelengths. The system and method utilize N+1 wavelength translator devices in order to provide protected transport for N wavelengths.

### RELATED APPLICATION

The present application relates to and claims priority from U.S. provisional application Ser. No. 60/637,010, filed Dec. 17, 2004, titled “METHOD AND APPARATUS FOR PROTECTING OPTICAL SIGNALS WITHIN A WAVELENGTH DIVISION MULTIPLEXED ENVIRONMENT”, the complete subject matter of which is hereby expressly incorporated in its entirety.

### BACKGROUND OF THE INVENTION

The present invention relates generally to optical communication systems and, more particularly, to methods and apparatus for protecting optical signals within a wavelength division multiplexed (WDM) optical communication environment.

FIG. 1 illustrates a conventional point-to-point communication system 100 with redundant communication paths between terminals 110 and 111. Information is exchanged between terminal 110 and terminal 111 using four WDM communication fibers. Information flows from terminal 110 to terminal 111 via a working client transmit signal (denoted WDM Signal, (W-1) 150) and a protection client transmit signal (denoted WDM Signal (P-1) 151). The information contained within WDM Signal (W-1) 150 and WDM Signal (P-1) 151 is identical. Likewise, information flows from terminal 111 to terminal 110 via working signal WDM Signal (W-2) 152 and protection WDM Signal (P-2) 153. The information contained within WDM Signal (W-2) 152 and WDM Signal (P-2) 153 is identical.

The WDM Signal (W-1) 150 is formed from associated client signals, such as working client transmit signals 120a to 120c. The client transmit signals 120a to 120c arrive at terminal 110 as “fixed wavelength” “non-colored” optical signals (e.g., 850 nm, 1310 nm, or 1550 nm). Each fixed wavelength, non-colored client signal is first translated to a unique “colored” wavelength via a series of wavelength translator devices 130a to 130c. A “colored wavelength” is defined to be one wavelength within a set of closely spaced wavelengths within a particular optical spectrum band (e.g., the ITU defined “C” band). Each translator device 130a to 130c is used to translate one client signal.

FIG. 2 illustrates a conventional implementation of a wavelength translator device 200 used to convert a fixed wavelength non-colored client signal to 1-of-N “colored” wavelengths. The type of wavelength translator shown in FIG. 2 will be referred to as a “Type 1” wavelength translator. Each Type 1 wavelength translator includes, among other things, a client optical-to-electrical (O/E) converter 201, client signal processing 202, line signal processing 203, and an electrical signal to 1 of N optical (E/O) wavelength converter 204. The O/E converter 201 converts an in-coming fixed wavelength optical signal into an electrical signal, while the E/O converter 204 converts an electrical signal to one of N different optical wavelengths (λ1 to λN).

Returning to FIG. 1, once the N unique wavelengths (λ1 to λN) are generated, the N signals are forwarded to an optical multiplexer 140. The optical multiplexer 140 multiplexes the N signals from N fibers onto a single fiber to form WDM signal (W-1) 150 which is then forwarded onto terminal 111. A similar set of operations occur on protection client transmit signals 121a to 121c.

A system (not shown) external to communications system 100 forwards information to terminal 110 in a duplicate manner by sending duplicate copies of information to terminal 110 using working and protect client interfaces. For example, the information sent to terminal 110 via each of client transmit signals 120a and 121a is exactly the same. For this case, client transmit signals 120a and 121a form a “working and protect” client pair, thereby resulting in identical information on WDM signals 150 and 151. Normally, WDM signal 150 is routed along a path separate and distinct from the path along which the WDM signal 151 is routed. Diverse routing between WDM signals 150 and 151 is provided in order that, if WDM signal 150 fails, the identical information is still made available to terminal 111 via WDM signal 151. Therefore, successful transmission is provided from terminal 110 to terminal 111 when either WDM signal 150 or WDM signal 151 is fault-free. At terminal 111, individual wavelengths are demultiplexed from the in-coming WDM signal 150 or 151 using optical demultiplexers 160 and 161. The optical demultiplexers 160 and 161 demultiplex the in-coming WDM signals 150 and 151, respectively, each into N unique wavelengths. The resulting N wavelengths are forwarded to N wavelength translators 170a to 170c.

FIG. 3 illustrates a conventional wavelength translator 300 used to convert 1-of-N colored wavelengths to a fixed wavelength non-colored client signal. The type of wavelength translator 300 shown in FIG. 3 will be referred to as a “Type 2” wavelength translator. Each Type 2 wavelength translator 300 converts a 1-of-N colored wavelength to a fixed non-colored wavelength. The resulting fixed non-colored wavelengths are forwarded to their corresponding client interfaces.

However, conventional communications systems experience certain disadvantages. As shown in FIG. 1, in order to provide for the protected transmission of N optical signals in one direction, 2N Type 1 wavelength translators, 2N Type 2 wavelength translators, two N-to-1 multiplexers, and two 1-to-N demultiplexers are required. Each Type 1 wavelength translator 200 includes one O/E converter 201 and one E/O converter 204. The E/O converters 204 are costly and add significant expense to the overall system 100.

A need exists for improved methods and apparatus for protecting optical signals within a wavelength division multiplexed environment.

### BRIEF DESCRIPTION OF THE INVENTION

A wavelength division multiplexed communications device is provided that comprises input lines configured to receive client signals, multiple electrical to optical (E/O) line converters converting the client signals into associated optical line signals, and routing elements. The routing elements connect the client signals to the E/O line converters. A line optical interface is used to transmit optical line signals, and a protection E/O line converter is provided and configured to replace a selected one of the multiple E/O line converters upon detection of a failure. The client signals may represent unprotected client signals or working and protect client signal pairs. Optionally, all of the E/O line converters may be protected with a single protection E/O line converter. The multiple E/O line converters and the protection E/O line converter form a P for N line converter protection group, where N equals the total number of client signals (protected or unprotected) and P differs from N.

In an alternative embodiment, an optical communications system is provided that comprises first and second terminals and an optical communications path configured to convey wavelength division multiplexed (WDM) signals from the first terminal to the second terminal. The first terminal receives client signals and includes a P for N line protection group that converts and reroutes the client signals into WDM signals. A total of N client signals is provided and received by the first terminal, while P does not equal N.

Optionally, the P for N line protection group may include N O/E line converters and N E/O line converters associated in a one to one relation with the N client signals. Optionally, the P for N line protection group may include N E/O line converters while the system further comprises a cross connect that interconnects information within the client signals to the E/O line converters.

In accordance with an alternative embodiment, a method is provided for protecting optical signals within a WDM environment. The method includes providing client signals and routing the client signals through a P for N line protection group, where N equals the total number of client signals and P does not equal N. The method further includes converting the client signals to optical signals and multiplexing the optical signals to produce WDM optical signals. The method further includes detecting failures within the WDM environment, where routing includes rerouting multiple client signals through a common protection E/O converter in the P for N line protection group based upon failure detection.

Optionally, the common protection E/O converter may transmit over a predetermined wavelength dedicated to protection transmissions. Optionally, the common protection E/O line converter may be tunable to transmit over a variety of wavelengths not dedicated to protection transmissions.

### BRIEF DESCRIPTION OF THE DRAWINGS

FIG. 1 illustrates a block diagram of a conventional point-to-point communications system.

FIG. 2 illustrates a block diagram of a Type 1 wavelength translator utilized in a conventional communications system.

FIG. 3 illustrates a block diagram of a Type 2 wavelength translator utilized in a conventional communications system.

FIG. 4 illustrates a block diagram of a WDM optical communications system configured in accordance with an embodiment of the present invention.

FIG. 5 illustrates a conventional point-to-point communication system during operation when a fiber cut failure is experienced.

FIG. 6 illustrates a block diagram of a system formed in accordance with an embodiment of the present invention during operation when a fiber cut is experienced.

FIG. 7 illustrates a conventional point-to-point communication system during operation when a line transmitter failure is detected.

FIG. 8 illustrates a block diagram of an embodiment of the present invention during operation when a line transmitter failure is experienced and the system utilizes fixed colored multiplexers and demultiplexers.

FIG. 9 illustrates a block diagram of an embodiment of the present invention utilizing colorless multiplexers and demultiplexers during operation when a line transmitter failure is detected.

FIG. 10 illustrates a block diagram of a conventional system during operation when a line receiver failure is detected.

FIG. 11 illustrates a block diagram of an embodiment of the present invention utilizing fixed colored multiplexers and demultiplexers during operation when a line receiver failure is detected.

FIG. 12 illustrates a block diagram of an embodiment of the present invention utilizing colorless multiplexers and demultiplexers during operation when a line receiver failure is detected.

FIG. 13 illustrates a block diagram of an embodiment of the present invention utilizing 2 for N line converter protection.

FIG. 14 illustrates a block diagram of an embodiment of the present invention utilizing a simple electronic multiplexer configuration.

FIG. 15 illustrates a block diagram of a hybrid optical multiplexer utilized in accordance with an embodiment of the present invention.

FIG. 16 illustrates a block diagram of a hybrid optical demultiplexer utilized in accordance with an embodiment of the present invention.

FIG. 17 illustrates a block diagram of a reconfigurable optical add/drop multiplexer/demultiplexer utilized in accordance with an embodiment of the present invention.

FIG. 18 illustrates a ring ROADM pair utilized in accordance with an embodiment of the present invention.

FIG. 19 illustrates a block diagram of a ring ROADM pair with client interfaces.

FIGS. 20A through 20C illustrate type A, type B and type C line converters, respectively.

FIG. 21 illustrates a block diagram of a conventional ring application.

FIG. 22 illustrates a block diagram of a ring application utilizing type B line converters in accordance with an embodiment of the present invention during operation when a line converter failure is detected.

FIG. 23 illustrates a block diagram of a ring ROADM pair using K colored add/drop ports, a single colorless add/drop port and K wavelengths in accordance with an embodiment of the present invention.

FIG. 24 illustrates a block diagram of a ring application utilizing type B line converters and ROADMs with at least one colorless add/drop port during detection of a line converter failure.

FIG. 25 illustrates a block diagram of a ring application utilizing type C line converters and cross connects in accordance with an embodiment of the present invention.

FIG. 26 illustrates a ring application utilizing type C line converters and cross connects in accordance with an embodiment of the present invention during a converter failure.

FIG. 27 illustrates a block diagram of a ring application formed in accordance with an embodiment of the present invention when multiple converter failures are experienced.

FIG. 28 illustrates a block diagram of a ring application formed in accordance with an embodiment of the present invention when both a fiber cut and a converter failure are experienced.

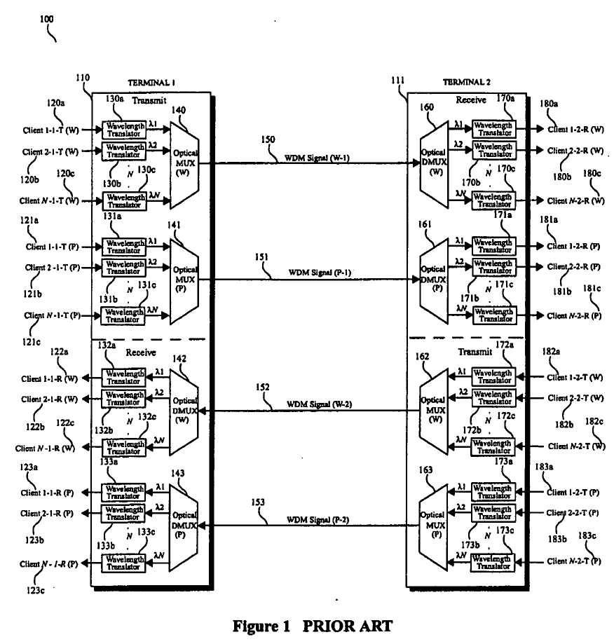

### DETAILED DESCRIPTION OF THE INVENTION

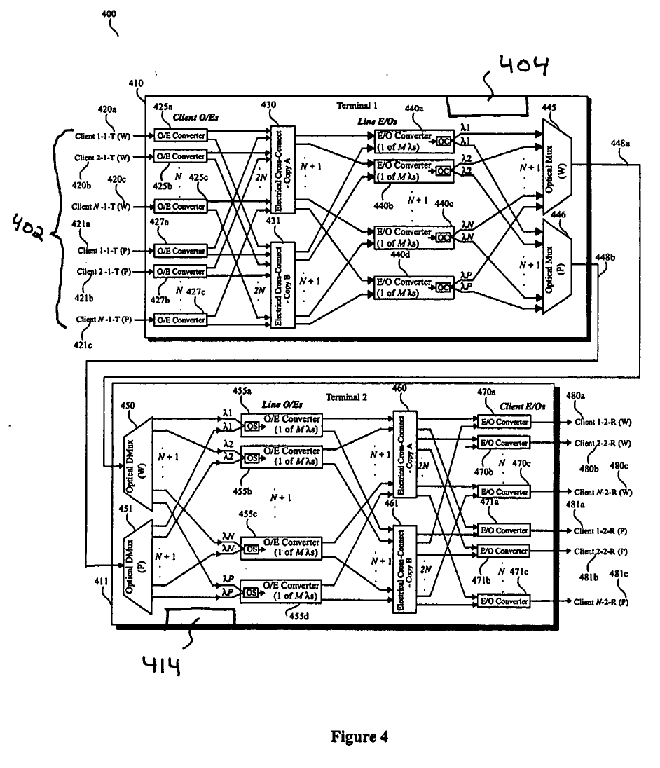

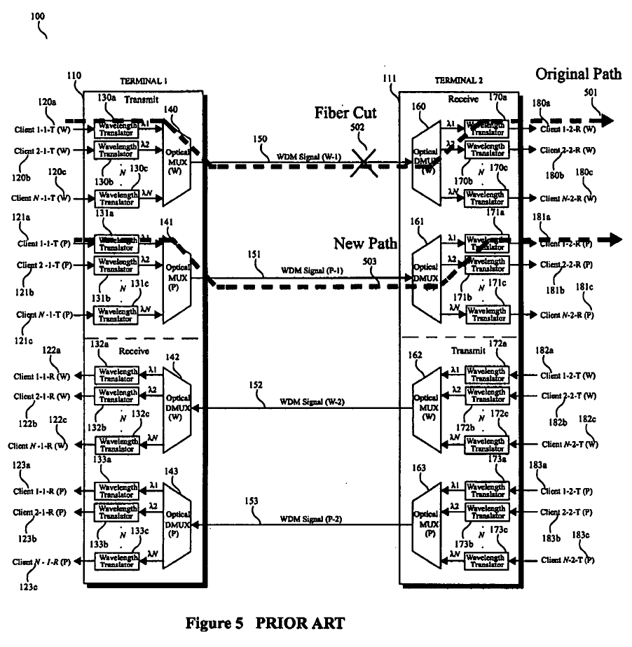

FIG. 4 illustrates a WDM optical communications system 400 configured in accordance with one embodiment of the present invention. The system 400 includes terminals 410 and 411 that are configured to support N client interfaces 402 by conveying N working and protect client pairs from terminal 410 to terminal 411. A set of components (not shown) similar to what is shown in FIG. 4 could be used to convey working and protect client pairs in the opposite direction from terminal 411 to terminal 410. As explained below, the system 400 supports M wavelengths which may be greater than or equal to N, where N is the number of working and protect client pairs. In the embodiment of FIG. 4, the client optical to electrical conversion is separated from the line electrical to optical conversion. The system 400 utilizes less than 2N line electrical to optical (E/O) converters, and may utilize no more than N+1 line E/O converters.

The terminal 410 receives working client transmit signals 420a to 420c (denoted client 1-1-T (W) to client N-1-T (W)), where T represents transmit and W represents working. The terminal 410 also receives protect client transmit signals 421a to 421c (denoted client 1-1-T (P) to client N-1-T (P)). The working client transmit signals 420a to 420c are provided to O/E converters 425a to 425c, while the protect client transmit signals 421a to 421c are provided to client O/E converters 427a to 427c. The working and protect client O/E converters 425a to 427c convert the 2N client transmit signals 420a to 421c from an optical format to an electrical format. Each client O/E converter 425a to 427c then broadcasts the corresponding resulting electrical signals to electrical cross-connects 430 and 431. The electrical cross-connects 430 and 431 have inputs and outputs that interconnect the client transmit signals 425a to 427c to corresponding line E/O converters 440a-440d. Hereafter, line E/O converters will also be interchangeable referred to as E/O line converters. The terminal 410 includes N+1 E/O line converters 440a-440d. The electrical cross-connects 430 and 431 select one of the two signals associated with a pair of working and protect client transmit signals (e.g., 420a and 421a, 420b and 421b, and 420c and 421c) to be provided to the E/O converters 440a to 440d. By way of example, the electrical cross-connects 430 and 431 may select the signal from each working and protect client pair based on predetermined signal characteristics, such as which of the identical working and protect signals has better signal quality and the like.

The electrical cross-connects 430 and 431 operate in cooperation with one another to forward only the selected signal from each working and protect client pair to a corresponding line E/O converter 440a-440d. Two electrical cross-connects 430 and 431 are implemented to provide redundance such that, in the event that one cross-connect 430 and 431 fails, the other cross-connect 430 and 431 will remain available to interconnect the O/E converters 425a to 427c with the E/O converters 440a to 440d. The cross-connects 430 and 431 are programmed with a common routing pattern to forward input signals associated with a single client O/E converter to a single line E/O converter. For instance, when cross-connect 430 is configured to forward the input signal from client O/E converter 425a to E/O converter 440a, cross-connect 431 is also configured to forward the input signal from client O/E converter 425a to E/O converter 440a. Hence, when E/O converter 440a receives the complete signal associated with client O/E converter 425a via cross-connect 430, then E/O converter 440a would also receive the complete signal associated with client O/E converter 425a via cross-connect 431.

Each cross-connect 430 and 431 may be capable of forwarding the signal received on any cross-connect input to any cross-connect output. Alternatively, the cross-connects 430 and 431 may be provided with more limited cross-connect capability such that only signals received on certain inputs are able to forward only to certain outputs.

In the embodiment shown in FIG. 4, the system 400 provides 1-for-N line E/O converter protection, such that one line E/O converter 440d is connected to protect against the failure of N other line E/O converters 440a-440c. Optionally, the system 400 may utilize redundancy that is greater than 1-for-N. For example, two protection converters may be used in order to provide for two for N protection. The line E/O converters 440a to 440c in FIG. 4 are referred to as “primary” line E/O converters, while line converter 440d is referred to as a protection line E/O converter. Protection line converters are only utilized when primary line converters fail. The combination of a group of primary line converters and their associated protection line converters are referred to as a “line converter protection group”. When N number of primary line converters are protected by P number of protection line converters, the protection group is referred to as a “P for N line converter protection group”. When there are no network failures, the light source within the protection line E/O converter 440d may be turned off, or it may be turned on, but may be transmitting some type of “null” signal.

Each line E/O converter 440a to 440d contains an optical transmitter device (e.g., a laser) and an optical coupler (OC). An optical coupler is one example of an optical directivity element. The optical coupler transfers half of the optical power inserted on its input interface to a first optical output interface, and the other half of the optical power to a second optical output interface. One optical coupler output interface is connected to a working optical multiplexer 445, and the other optical coupler output interface is connected to a protection optical multiplexer 446. Each of the optical multiplexers 445 and 446 multiplexes unique wavelengths from the N+1 line E/O converters 440a-440d, such that all N+1 wavelengths are transported over a single pair of working and protect fibers 448a and 448b, respectively. The optical transmitter device within a line E/O converter 440a-440d may be configured to emit a single “fixed” wavelength within a group of M wavelengths (referred to as a “fixed colored optical transmitter”), or alternatively, the line E/O converters 440a-440d may be dynamically tuned to emit any of M wavelengths (referred to as a “tunable optical transmitter”).

Additionally, the optical multiplexers 445 and 446 may have either “fixed colored” input ports or “colorless” input ports. For “fixed colored” input ports, a particular wavelength must be inserted onto a particular input port of the multiplexer (e.g., wavelength number 1 must be applied to input port number 1, wavelength number 2 must be applied to input port number 2, etc.). For “colorless” input ports, any supported wavelength can be applied to a given colorless input port of the multiplexer (e.g., wavelength number 1 or wavelength number 2 or wavelength number N can be applied to a given colorless input port). An optical multiplexer that has all “fixed colored” input ports will be hereafter referred to as a “fixed colored multiplexer”. An optical multiplexer that has all “colorless” input ports will be hereafter referred to as a “colorless multiplexer”.

The working and protect fibers 448a and 448b are connected to terminal 411 at inputs to optical demultiplexers 450 and 451. The optical demultiplexers 450 and 451 may have either “fixed colored” output ports or “colorless” output ports. For “fixed colored” output ports, a particular wavelength must be placed onto a given output port of the demultiplexer (e.g., wavelength number 1 must be applied to output port number 1, wavelength number 2 must be applied to output port number 2, etc.). For “colorless” output ports, any supported wavelength can be applied to a given colorless output port of the demultiplexer (e.g., wavelength number 1 or wavelength number 2, or wavelength number N can be applied to a given colorless output port). An optical demultiplexer that has all “fixed colored” output ports will be hereafter referred to as a “fixed colored demultiplexer”. An optical demultiplexer that has all “colorless” output ports will be hereafter referred to as a “colorless demultiplexer”.

The terminal 411 includes a receive path, including optical demultiplexer 450 which demultiplexes the working WDM signal on working fiber 448a and demultiplexer 451 which demultiplexes the protection WDM signal on protection fiber 448b. Each optical demultiplexer 450 and 451 demultiplexes up to N wavelengths from a possible M wavelengths, and forwards each unique wavelength to a line O/E converter 455a to 455d. Hereafter, line O/E converters will also be interchangeable referred to as O/E line converters. Typically the line O/E converter 455a to 455d contains a broad-band optical to electrical converter (e.g., one that can convert any isolated single wavelength within the entire “colored” WDM band). Each line O/E converter 455a to 455d contains a simple 2 to 1 optical switch (OS). An optical switch is one example of an optical directivity element. The optical switch is capable of selecting an optical signal from either optical demultiplexer 450 and 451. The optical switch includes two “signal monitors” which monitor the quality associated with the two optical signals received from the demultiplexers 450 and 451. The optical switch chooses the better of the two signals, and forwards the selected signal to its associated O/E converter device 455a to 455d. Once the optical signals are converted to an electrical signal, each line O/E converter 455a to 455d broadcasts the associated electrical signal to two electrical cross-connects 460 and 461 within the terminal 411. There are two cross-connects 460 and 461 for redundancy purposes. The cross-connects 460 and 461 forward the appropriate received signal to the appropriate receive client interface 480a to 481c.

Each cross-connect 460 and 461 may be capable of forwarding the signal received on any cross-connect input to any cross-connect output. Optionally, the cross-connects 460 and 461 may be more limited. Each cross-connect 460 and 461 forwards the same input signal to a given working and protect client pair. For instance, if E/O converter 470b receives the complete signal associated with O/E converter 455a via cross-connect 460, then E/O converter 470b would also receive the complete signal associated with O/E converter 455a via cross-connect 461. Also, E/O converter 471b would receive the complete signal associated with O/E converter 455a via each of cross-connects 460 and 461. Each client E/O converter 470a to 471c selects the better of the received identical input signals, and converts the selected signal to optical format. After conversion to the optical domain, the resulting optical signal is passed to the corresponding client interface among client signals 480a to 481c (denoted client 1-2-R (W) to client N-2-R (P).

Terminal 410 includes control logic 404 that receives signal characteristic feedback from the cross-connects 430 and 431, the line E/O converters 440a to 440d and multiplexers 445 and 446, regarding, among other things, signal quality at the input and/or output ports of each component. Based on the signal characteristic feedback, the control logic 404 commands the cross-connects 430 and 431, and the multiplexers 445 and 446 to reroute signal paths through select ones of E/O converters 440a to 440d.

Terminal 411 includes control logic 414 that receives signal characteristic feedback from the demultiplexers 450 and 451, O/E converters 455a to 455d, and electrical cross-connects 460 and 461, regarding, among other things, signal quality at the input and/or output ports of each component. Based on the signal characteristic feedback, the control logic 414 commands the demultiplexers 450 and 451 and cross-connects 460 and 461 to reroute signal paths through select ones of O/E converters 455a to 455d.

Optionally, the system 400 may be constructed using any combination of optical transmitter device types and optical multiplexer/demultiplexer device types.

Next, the operation of the conventional system 100 and the system 400 will be described in connection with certain failure scenarios, including a fiber cut failure, transmitter failure, and receiver failure.

FIG. 5 illustrates the operation of the conventional system 100 when a fiber cut failure is experienced. In FIG. 5, a dashed line is illustrated to denote transmit paths through the working and protect client transmit signals 120a and 121a and the corresponding working and protect client receive signals 180a and 181a. The working and protect client receive signals 180a and 181a are sent to the same receive client. The receive client is free to select data from either signal. The original signal path 501 is from working client transmit signal 120a to working client receive signal 180a. When a fiber cut 502 occurs on the fiber associated with the original path through working client transmit signal 120a, the receive client switches to the new path 503. In this scenario, the receive client receives both the original path 501 (the working path) and the new path 503 (the protection path), and the client switches between the two paths 501 and 503, while the terminals 110 and 111 provide no protection switching. Instead, the switching occurs outside of the system 100.

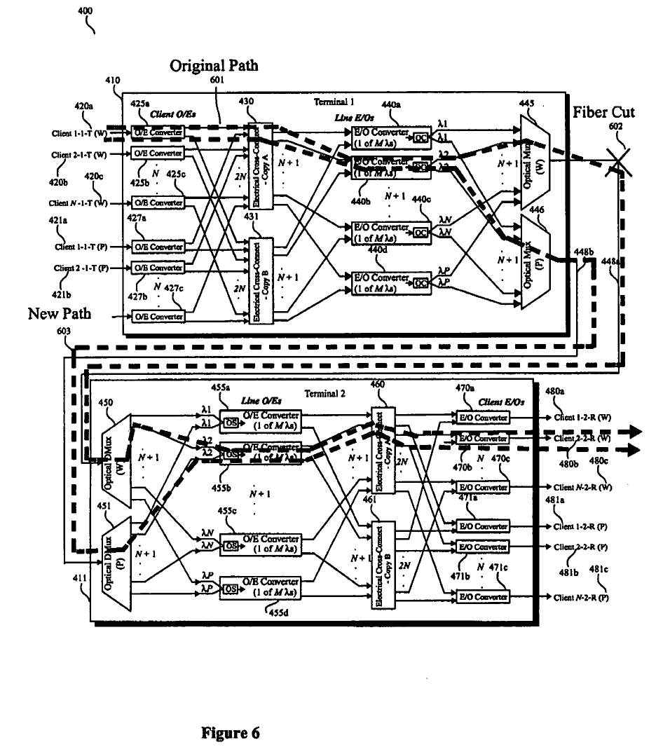

FIG. 6 depicts the operation of system 400 during a fiber cut. In FIG. 6, an original path 601 is provided from working client transmit signal 420a to working client receive signal 480b. When a fiber cut 602 occurs on working fiber 448a associated with the original path 601, the associated line O/E converter 455b at the receiver terminal 411 detects the fiber cut (via a loss of signal indicator). The O/E converter 455b automatically switches to a new path 603. The new path 603 is provided from working client transmit signal 420a, through protect fiber 448b. Hence, when a fiber cut 602 occurs, the system 400 automatically performs a protection switch, and the receive client performs no action. Both working and protect client E/O converters 470b and 471b receive the same signal from line O/E converter 455b.

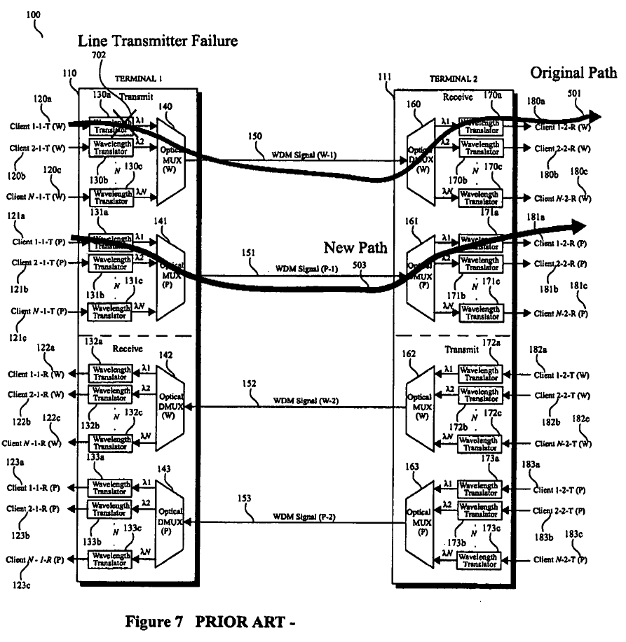

FIG. 7 illustrates the operation of the conventional system 100 when a line transmitter failure is experienced. In FIG. 7, the original path 501 is from working client transmit signal 120a to working client receive signal 180a. Working client receive signals 180a and 181a are sent to the same receive client. The receive client is free to select its data from either signal. When the line transmitter associated with the original path 501 fails at 702, the receive client switches to the new path 503. In this scenario, the receive client receives both the original path 501 (the working path) and the new path 503 (the protection path), and the receive client makes the switch between the two paths while no protection switching occurs in the system 100.

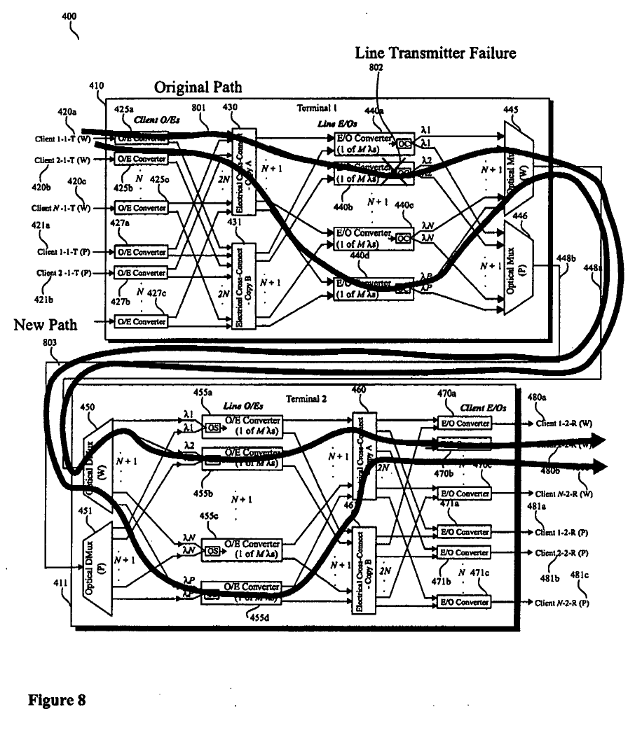

FIG. 8 depicts the system 400 in operation during a line transmitter failure. The terminal 410 includes optical signal monitoring circuitry that monitors the quality of the optical signals produced by the E/O converters 440a to 440d. When the quality of the optical signal from any of E/O converters 440a-440c is unacceptable, the terminal 410 commands the cross-connects 430 and 431 to redirect a corresponding electrical signal from the failing E/O converter 440a-440c to the protection E/O converter 440d. In the example of FIG. 8, it is assumed that the optical transmitters in E/O converters 440a to 440d, the optical input ports of the multiplexers 445, 446 and the optical output ports of the demultiplexers 450, 451 are “fixed colored”. In a fixed colored system, each line E/O converter 440a to 440d in terminal 410 transmits optical signals at a predefined, dedicated, unique wavelength.

In FIG. 8, the original signal path 801 is from working client transmit signal 420a to working client receive signal 480b through E/O converter 440b and O/E converter 445b at a wavelength of λ2. When the line transmitter in E/O converter 440b associated with the original path 801 fails at 802, the signal that was previously directed to line E/O converter 440b is automatically redirected by the electrical cross-connect 430 to protection line E/O converter 440d. The terminal 410 commands the electrical cross-connect 430 to perform such redirection. The protection line E/O converter 440d outputs an optical signal at a protection wavelength λP. The signal having protection wavelength λP is then wavelength division multiplexed onto fiber 448a, where it is received at terminal 411.

If the system 400 uses “fixed colored multiplexers,” then the protected signal having protection wavelength λP is of a different frequency than that of λ2 associated with E/O converter 440b and O/E converter 455b. Therefore, at terminal 411 the optical demultiplexer 450 directs the protection wavelength λP to the protection line E/O converter 455d within terminal 411. The terminal 411 commands the electrical cross-connect 460 within terminal 411 to direct the protected signal from O/E converter 455d to client E/O converter 470b. In this scenario, the system 400 automatically performs the necessary protection switching, and the receive client performs no action. After the switching occurs, both working and protect client E/O converters 470b and 471b receive the same signal from line O/E converter 455d.

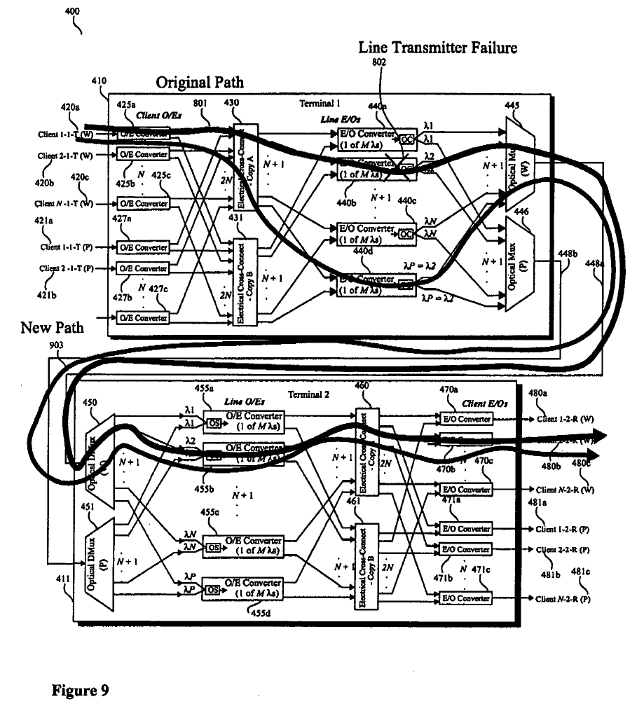

FIG. 9 illustrates the system 400 but with multiplexers 445 and 446 and demultiplexers 450 and 451 that are colorless, and with line E/O converters 440a to 440d that contain tunable optical transmitters (hereinafter referred to as tunable E/O converters). FIG. 9 depicts the system 400 in operation during a line transmitter failure (also referred to as a line E/O converter failure). Working client transmit signal 420a and working client receive signal 480b form the original signal path 801. When the line transmitter of E/O converter 440b associated with the original path 801 fails at 802, the signal that was previously directed to line E/O converter 440b is now directed to protection line E/O converter 440d via the electrical cross-connect 430. The terminal 410 detects the failure of the optical signal output by the E/O converter 440b and controls the cross-connects 430 and 431 to redirect the electrical signal to the protect E/O converter 440d. The terminal 410 also tunes the optical transmitter within line E/O converter 440d to emit an optical signal at a wavelength λ2 which was previously associated with E/O converter 440b. Since optical multiplexer 445 is colorless, multiplexer 445 can accept any wavelength from E/O converter 440d, and therefore is commanded to accept λ2. The terminal 410 sets the protection wavelength λP equal to λ2 which is then multiplexed onto working fiber 448a, where it is received at terminal 411. Since the protection wavelength is equal to wavelength λ2, the protected signal may continue to be directed to O/E converter 455b. In this case, (unlike in FIG. 8) the terminal 410 performs a single protection switch, terminal 411 performs no action, and the receive client performs no action. Although not explicitly shown in FIG. 9, after the switch occurs, both working and protect client E/O converters 470b and 471b receive the same signal from line O/E converter 455b.

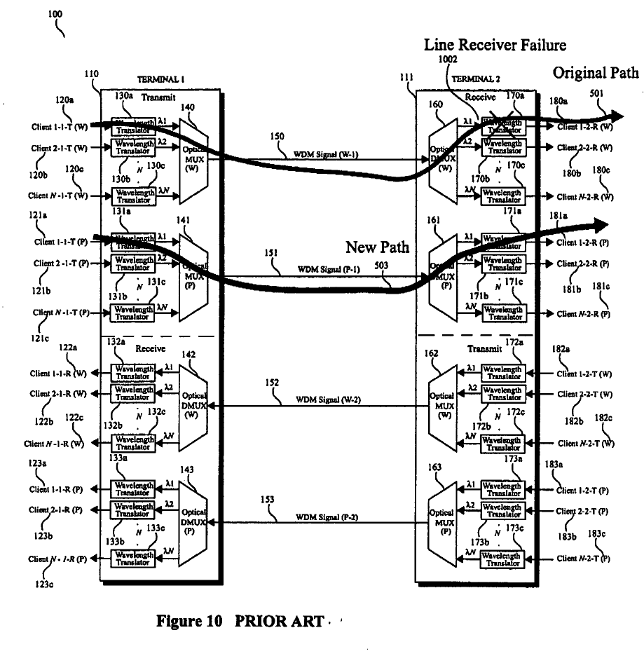

FIG. 10 depicts the operation of the conventional system 100 during a failure at a line receiver wavelength translator 170a. In FIG. 10, the pair of working and protect client transmit signals 120a and 121a communicate with the pair of working and protect client receive signals 180a and 181a which are both sent to the same receive client. The receive client is free to select its data from either of working and protect client receive signals 180a and 181a. The original signal path 501 is from working client transmit signal 120a to working client receive signal 180a. When the line receiver wavelength translator receiver 170a associated with the original path fails 1002, the receive client switches to the new path 503. In this scenario, the receive client receives both the original path 501 and the new path 503, and it is the receive client that makes the switch between the two paths. No protection switching occurs in the system 100 itself, instead, switching occurs outside of the system 100.

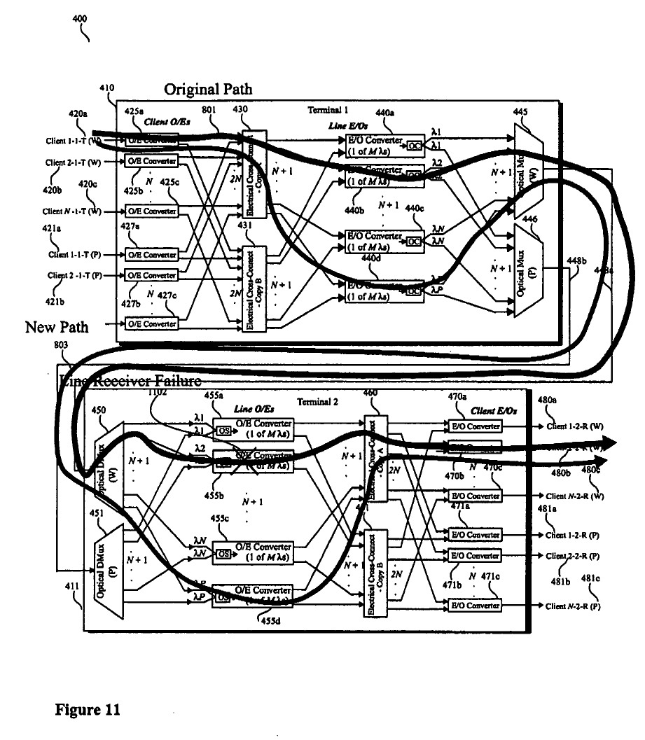

FIG. 11 depicts the system 400 in operation during a failure of a line receiver within line O/E converter 455b. In FIG. 11, the system 400 includes working and protect client transmit signals 420a and 421a, and the corresponding working and protect client receive signals 480b and 481b. The original signal path 801 is between working client transmit and receive signals 420a and 480b. In the example of FIG. 11, the system 400 uses “fixed colored” multiplexers 445 and 446, “fixed colored” demultiplexers 450 and 451, and fixed colored E/O converters 440a to 440d. When the terminal 410 detects that the line receiver in the line O/E converter 455b associated with the original path fails at 1102, the terminal 410 commands the cross-connect 430 to redirect the signal that was previously directed through line E/O converter 440b to protection line E/O converter 440d. The protected signal transmitted by E/O converter 440d has a protection wavelength λP (which is different from wavelength λ2) which is then multiplexed onto working fiber 448a, and then received at terminal 411. At terminal 411, the demultiplexer 450 directs the protection wavelength λP to protection O/E converter 455d. The terminal 411 then commands the electrical cross-connect 460 to direct the protected signal from protection O/E converter 455d to client E/O converter 470b. In the example of FIG. 11, the system 400 automatically performs the protection switching, and the receive client performs no action. Although not explicitly shown in FIG. 11, after the switching occurs, both working and protect client E/O converters 470b and 471b receive the same signal from line O/E converter 455d.

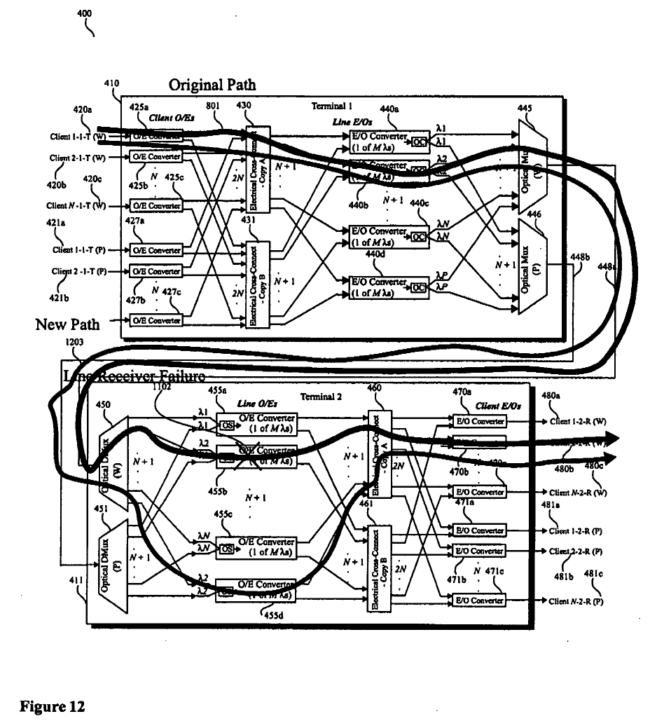

FIG. 12 depicts the same system 400 as shown in FIG. 11, but now with colorless multiplexers 445 and 446 and demultiplexers 450 and 451, and with colorless line E/O converters 440a-440d, (e.g., contain tunable optical transmitters). FIG. 12 depicts the system 400 in operation during a failure of a line receiver in an O/E converter 455b. In FIG. 12, the working client transmit signal 420a and working client receive signal 480b form the original signal path 801. When the system 400 uses “colorless” multiplexers and demultiplexers and tunable optical transmitters, and the line receiver in the line O/E converter 445b associated with the original path fails at 1102, terminal 410 takes no action, instead, only terminal 411 performs switching. Terminal 411 receives a multiplexed optical signal along working fiber 448a having a wavelength division multiplexed optical signal component with a wavelength λ2 which was output from E/O converter 440b. The terminal 411 commands the colorless demultiplexer 450 to redirect the wavelength λ2 WDM component to the O/E converter 455d. On command, the colorless optical demultiplexer 450 can direct any received wavelength to any output port of the demultiplexer 450. Electrical cross-connect 460 within terminal 411 is then used to direct the signal with wavelength λ2 from O/E converter 455d to client E/O converter 470b. In the example of FIG. 12, the terminal 410 takes no action while the optical demultiplexers 450 and 451 in terminal 411 redirect the signal with wavelength λ2 from O/E converter 455b to O/E converter 455d, and the two cross-connects 460 and 461 in terminal 411 direct the output from O/E converter 455d to the two client E/O converters 470b and 471b.

As discussed above for a cut of an individual line fiber all services are protected without the use of protection line converters. When using 1 for N line E/O converter protection, the system 400 provides service protection against a a single line E/O converter failure. When using 1 for N line O/E converter protection, the system 400 provides service protection against a single line O/E converter failure. When using fixed colored multiplexers and demultiplexers and fixed colored optical transmitters for each 1 for N line converter protection group, an optical wavelength should be dedicated strictly for protection purposes. The dedicated wavelength is only used for the case where an E/O line converter fails at the transmit terminal, or when an O/E line converter fails at the receive terminal. By way of example, when a WDM system containing 32 wavelengths is available, and 1 for 7 line converter protection is implemented, 28 wavelengths are dedicated to active services, and four wavelengths are reserved for protection purposes.

When dedicated protection wavelengths are utilized as described above, when a line E/O converter fails at the transmit terminal, the protection line E/O converter is used at the transmit terminal, the protection line O/E converter is used at the receive terminal, and the associated dedicated protection wavelength is used. The electrical cross-connect devices at both the transmit and receive terminals are used to redirect the protection wavelength. When a line O/E converter fails at the receive terminal, the protection line O/E converter is used at the receive terminal, the protection line E/O converter is used at the transmit terminal, and the associated dedicated protection wavelength is used. The electrical cross-connect devices at both the transmit and receive terminals are used to direct the protection wavelength. For a given 1 for N line converter protection group, the simultaneous failure of a line E/O converter at the transmit terminal and a line O/E converter at the receive terminal cannot be protected against, unless the line E/O converter and the line O/E converter are transporting the same wavelength.

As explained above, when using colorless multiplexers/demultiplexers & tunable optical transmitters (1 for N Protection), certain assumptions are true. For each 1 for N line converter protection group an optical wavelength does not need to be dedicated strictly for protection purposes. By way of example, when a WDM system containing 32 wavelengths is available, and 1 for 8 line converter protection is implemented, 32 wavelengths are dedicated to active services, and no wavelengths are reserved for protection purposes. When a line E/O converter fails at the transmit terminal, the protection line E/O converter is used at the transmit terminal, and the protection E/O converter is “tuned” to the wavelength associated with the failed E/O converter. The electrical cross-connect device at the transmit terminal is used to direct the client signals (associated with the failure) to the protection E/O converter. No action is taken at the receive terminal. When a line O/E converter fails at the receive terminal, the protection line O/E converter is used at the receive terminal, and the colorless optical multiplexer at the receive terminal is used to redirect the wavelength of the associated failed O/E converter to the protection O/E converter. The electrical cross-connect devices within the receive terminal are used to direct the signal associated with the protection O/E converter to the client interfaces associated with the failed O/E converter. No action is taken at the transmit terminal. For a given 1 for N line converter protection group, the simultaneous failure of a line E/O converter at the transmit terminal and a line O/E converter at the receive terminal can be protected against, even for the case where the line E/O converter and the line O/E converter are not transporting the same wavelength.

Protection against multiple failures within a converter protection group can achieved by increasing the number of protection converters within a given converter protection group. For instance, instead of 1 for N line converter protection, 2 for N line converter protection, or 3 for N line converter protection can be implemented. In general, the larger the value of N, the larger the value of P when implementing P for N protection.

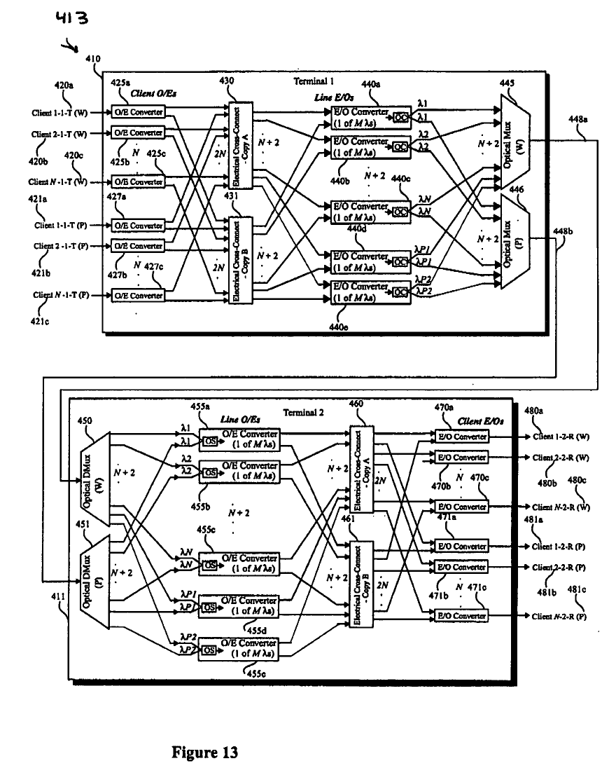

FIG. 13 illustrates a system 413 having P for N line converter protection for the case where P is equal to 2. In FIG. 13, there are N+2 line E/O converters 440a-440e within the transmit terminal 410, and N+2 line O/E converters 455a-455e within the receive terminal 411. For a cut of an individual line fiber all services are protected. When using P for N line E/O converter protection, the system 413 provides service protection against P number of line E/O converter failures within a line converter protection group. When using P for N line O/E converter protection, the system 413 provides service protection against P number of line O/E converter failures within a line converter protection group.

When the system 413 uses fixed colored multiplexers/demultiplexers and fixed colored optical transmitters in P for N Protection. For each P for N line converter protection group, P number of optical wavelengths are dedicated strictly for protection purposes. These wavelength are only used for the case where an E/O line converter fails at the transmit terminal, or when an O/E line converter fails at the receive terminal. Assuming a WDM system containing 32 wavelengths is available, and assuming 2 for 6 line converter protection is implemented, 24 wavelengths are dedicated to active services, and eight wavelengths are reserved for protection purposes. When a line E/O converter fails at the transmit terminal, the protection line E/O converter is used at the transmit terminal, the protection line O/E converter is used at the receive terminal, and the associated dedicated protection wavelength is used. The electrical cross-connect devices at both the transmit and receive terminals must be used to direct the protection wavelength.

When the system uses fixed colored multiplexers/demultiplexers and fixed colored optical transmitters and a line O/E converter fails at the receive terminal, the protection line O/E converter is used at the receive terminal, the protection line E/O converter is used at the transmit terminal, and the associated dedicated protection wavelength is used. The electrical cross-connect devices at both the transmit and receive terminals must be used to direct the protection wavelength. For a given 2 for N line converter protection group, one simultaneous failure of a line E/O converter at the transmit terminal and a line O/E converter at the receive terminal can be protected against (including the case where the wavelength associated with the E/O failure is different from the wavelength associated with the O/E failure). For the case where there are two E/O failures and two O/E failures, and the two wavelengths associated with the E/O failures are the same two wavelengths that are associated with the two O/E failures, then both E/O and both O/E failures can be protected against.

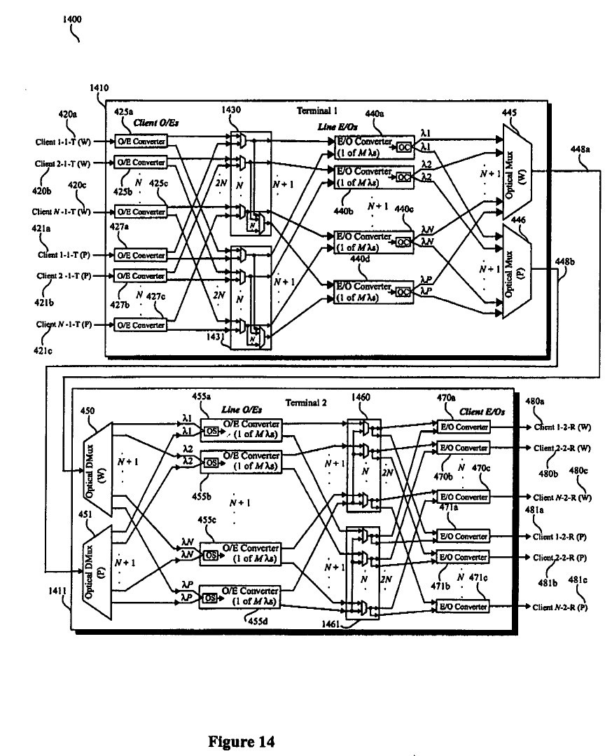

FIG. 14 shows a system 1400 that contains simple electrical multiplexing devices 1430, 1431, 1460, 1461 instead of electrical cross-connect devices. When using the electrical cross-connect devices, any two client interfaces could be grouped in order to form a a working and protect client pair. When the simple electrical multiplexing devices 1430, 1431, 1460, and 1461 are used in place of the electrical cross-connect devices, each client interface has a dedicated paired interface, as shown in FIG. 14. Therefore, the simpler electrical multiplexing device results in a less flexible system.

Although the system 1400 of FIG. 14 may be less flexible than the system 400 of FIG. 4, the system 1400 is still capable of performing the protection switching operations illustrated in FIGS. 6, 8, 9, 11, and 12. As was the case for the system 400, the system 1400 can operate with either fixed colored multiplexers/demultiplexers and fixed colored E/O line converters, or colorless multiplexers/demultiplexers and tunable E/O line converters.

An alternative to the “fixed colored” optical multiplexer and the “colorless” optical multiplexer is the so called “hybrid” optical multiplexer. The hybrid optical multiplexer contains multiple fixed colored input ports and one or more colorless input ports. Any wavelength (supported by the multiplexer) can be applied to the colorless input port(s). Similarly, the hybrid optical demultiplexer contains multiple fixed colored output ports and one or more colorless output ports. The hybrid optical demultiplexer can direct any received line wavelength to any colorless output port. In addition, the hybrid optical demultiplexer can direct each specific wavelength to a specific fixed colored output port.

For example, when the system supports 32 wavelengths, then its associated hybrid optical multiplexer with one colorless input port would contain a maximum of 33 input ports: 32 fixed colored input ports, and one colorless input port. If the system supports 32 wavelengths, then its associated hybrid optical multiplexer with P colorless input ports would contain a maximum of 32+P input ports: 32 fixed colored input ports, and P colorless input ports. Similarly, if the system supports 32 wavelengths, then its associated hybrid optical demultiplexer with one colorless output port would contain a maximum of 33 output ports: 32 fixed colored output ports, and one colorless output port. If the system supports 32 wavelengths, then its associated hybrid optical demultiplexer with P colorless output ports would contain a maximum of 32+P output ports: 32 fixed colored output ports, and P colorless output ports.

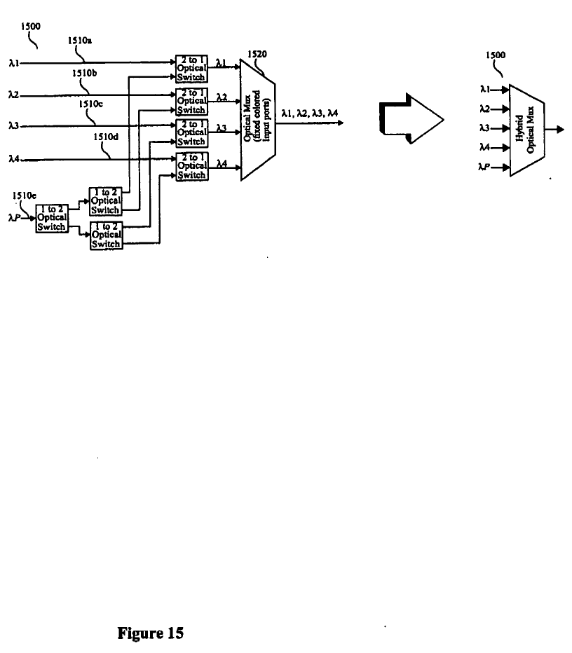

A hybrid optical multiplexer can be created by combining a fixed colored optical multiplexer with a group of optical switches. For example, FIG. 15 shows how a five input hybrid optical multiplexer can be formed using a four input fixed colored optical multiplexer and a group of optical switches. For this example, the created hybrid optical multiplexer contains four fixed colored input ports 1510a-d and one colorless input port 1510e. By way of example, if wavelength λ4 were to be applied to input 1510e, the three optical switches between input 1510e and the λ4 input of the fixed colored optical multiplexer would be set such that the input of each of the 1 to 2 optical switches is forwarded to the lower output of each switch and the lower input of the 2 to 1 optical switch is forwarded to the output of the switch.

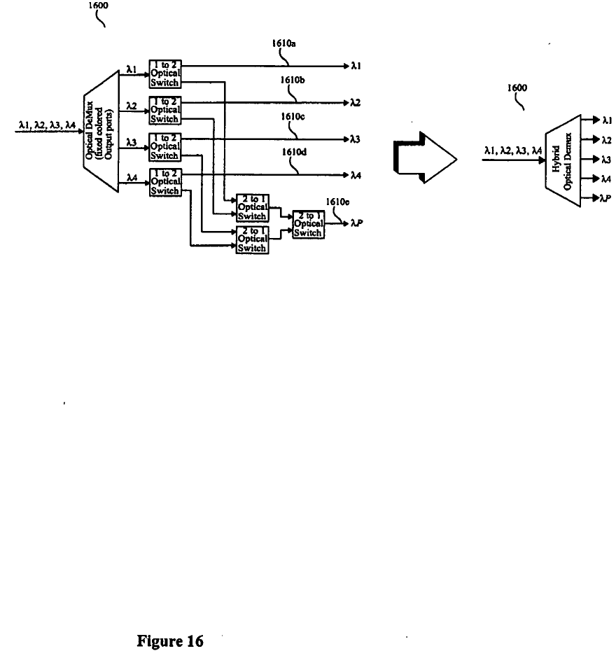

A hybrid optical demultiplexer can also be created by combining a fixed colored optical demultiplexer with a group of optical switches. For example, FIG. 16 shows how a five output hybrid optical demultiplexer can be formed using a four output fixed colored optical demultiplexer and a group of optical switches. For this example, the created hybrid optical demultiplexer contains four fixed colored output ports 1610a-d and one colorless output port 1610e. By way of example, if one desired to direct λ4 out of the fixed colored optical demultiplexer to the protection output 1610e, then the three optical switches between the λ4 output of the fixed colored optical demultiplexer and output 1610e would be set such that the input of the 1 to 2 switch is forwarded to the lower output of the switch and the lower input of each of the 2 to 1 switches is forwarded to the output of the corresponding switch.

Assuming that the colorless optical multiplexers and demultiplexers in FIGS. 9 and 12 are replaced with hybrid optical multiplexers (with one colorless port: for the protection channel), the protection operations shown in FIGS. 9 and 12 can be accomplished. That is to say, in order to perform the protection operations shown in FIGS. 9 and 12, only the multiplexer inputs/outputs attached to the protection line converters need to be equipped with colorless ports. Additionally, only the protection E/O line converter in FIGS. 9 and 12 needs to be a tunable type converter, and all other E/O line converters (i.e., the primary E/O line converters) can be of the fixed colored (non-tunable) type.

In order to construct ring configurations, a more complex multiplexing/demultiplexing device is utilized. Instead of using simple optical multiplexers and demultiplexers, the multiplexers are combined with optical switches. The switches allow for remote re-configuration of a given optical node residing on an optical ring.

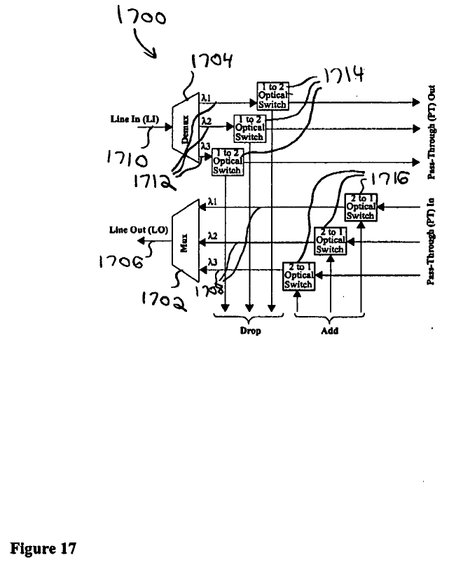

FIG. 17 illustrates a Reconfigurable Optical Add/Drop Multiplexer (ROADM) device 1700. The ROADM device 1700 includes a multiplexer 1702 having an output port 1706 and input ports 1708 and a demultiplexer 1704 having an input port 1710 and output ports 1712. Optical switches 1714 control “pass through out” and drop of wavelengths λ1-λ3 output by demultiplexer 1704. Optical switches 1716 control “pass through in” and add of wavelength λ1-λ3 input to the multiplexer 1702. As can be seen from FIG. 17, each demultiplexed signal on output ports 1712 that leaves the fixed colored optical demultiplexer 1704 (demux) is directed to a 1 to 2 optical switch 1714. Each 1 to 2 optical switch 1714 can direct its associated input optical signal to either a drop port or a pass-through port. Similarly, the fixed colored optical multiplexer 1702 (mux) receives its signals from a series of 2 to 1 optical switches 1716 (one switch for each multiplexer input). Each 2 to 1 optical switch 1716 allows either the signal from the add port or the signal from the pass-through port to be directed to the optical multiplexer 1702.

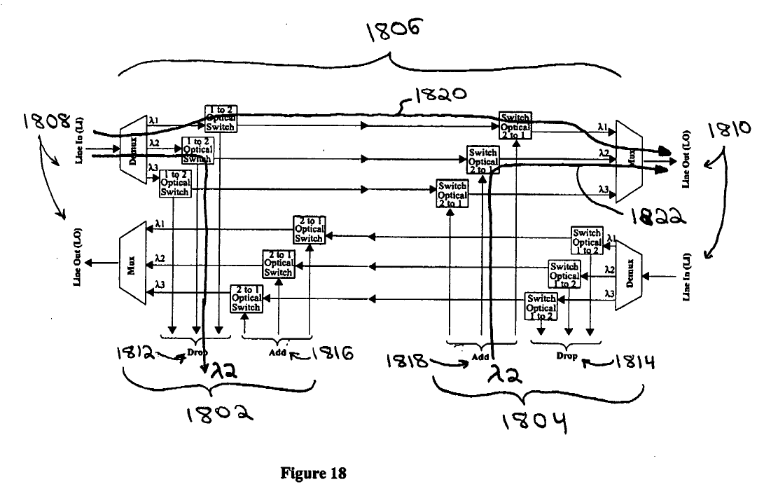

FIG. 18 illustrates two ROADM devices 1802 and 1804 interconnected to form a ring ROADM pair 1806. As can be seen from FIG. 18, the ring ROADM pair 1806 contains two bidirectional line interfaces 1808 and 1810, two sets of drop interfaces 1812 and 1814 (one set dedicated to each line interface), and two sets of add interfaces 1816 and 1818 (one set dedicated to each line interface). The configuration shown in FIG. 18 allows a wavelength that enters a given line interface 1808 or 1810 to be either dropped (by directing the wavelength to the drop port) or passed through to the output of the other line interface 1810 or 1808. The path 1820 represents a pass through path, while the path 1822 represents a dropped path. If a given wavelength (e.g.λ2) arriving on one line interface is directed to its associated drop port, then a wavelength of the same frequency (e.g., λ2) can be added to the other line interface (as depicted in FIG. 18). Optionally, the ring ROADM pair 1806 may include K add/drop ports that supports K wavelengths (rather than the three add/drop ports shown in FIG. 18).

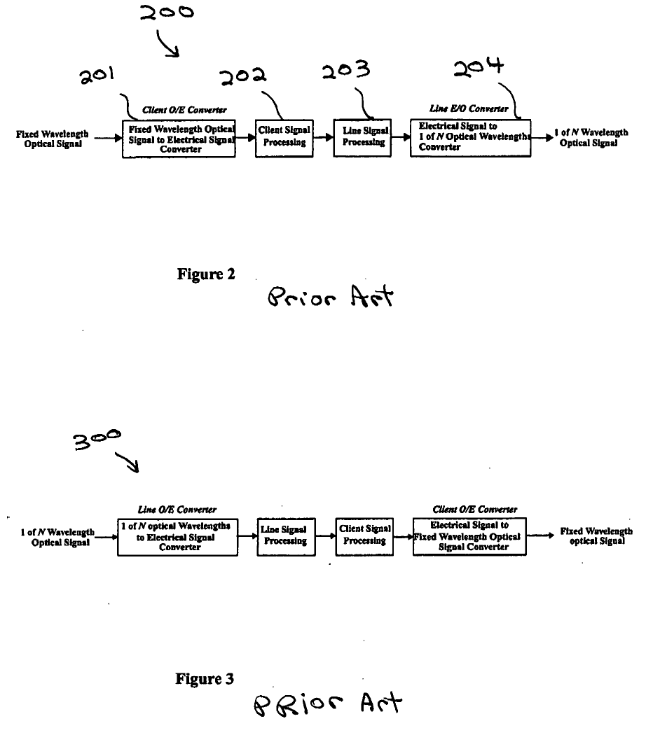

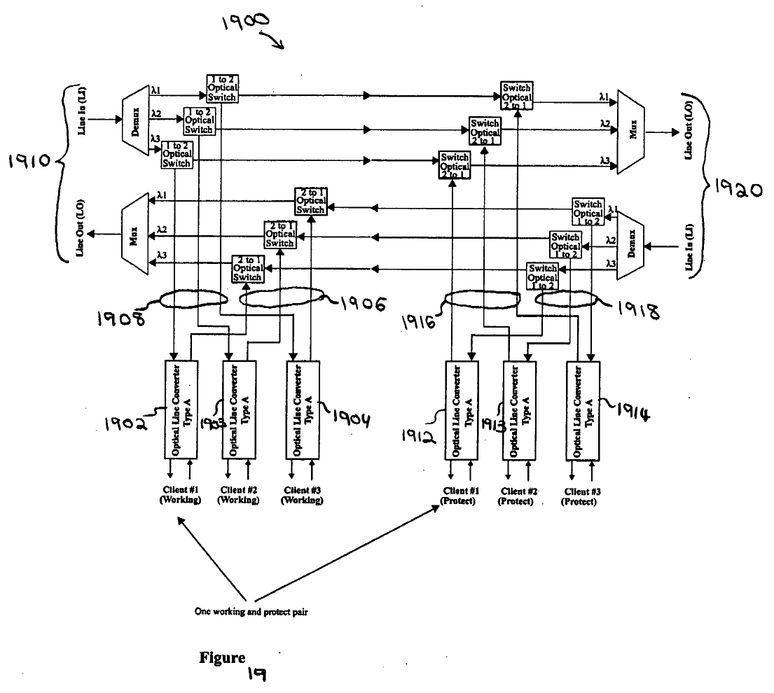

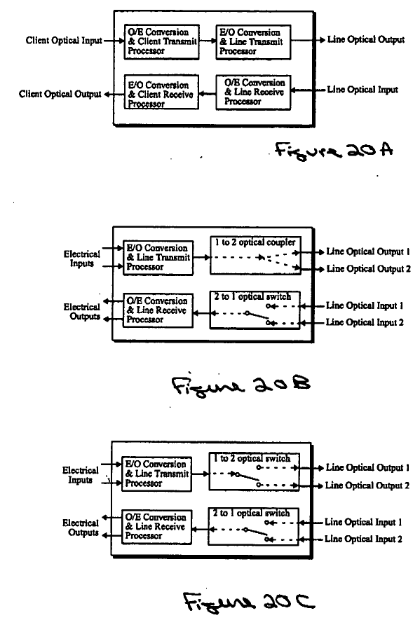

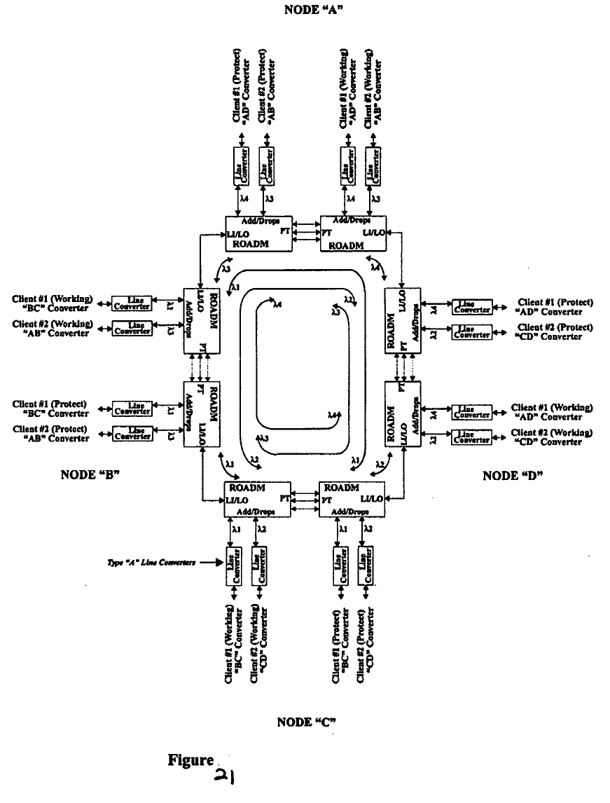

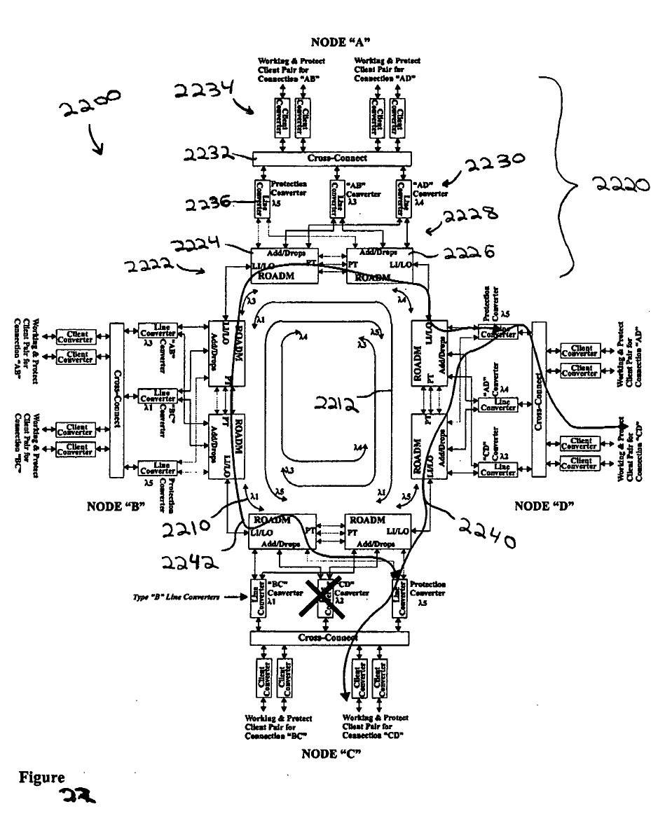

FIG. 19 illustrates a conventional ring ROADM pair 1900 that can be used within a conventional WDM ROADM network. The ring ROADM pair uses 1 for 1 line converter protection, in which line converters 1902-1904 are connected to the add/drop ports 1906 and 1908 of one line interface 1910 and are paired with line converters 1912-1914 that are connected to the same add/drop ports 1916 and 1918 of the other line interface 1920. In FIG. 19, client #1 interfaces to the WDM network via the client #1 working and protect optical line converter devices 1902 and 1912. The WDM network then is able to provide two dedicated redundant paths through the network. The optical line converter devices 1902-1904 and 1912-1914 shown in FIG. 19 combine the wavelength translator shown in FIG. 2 with the wavelength translator shown in FIG. 3 in order to create a single bidirectional line converter device. This combined “Type A” optical line converter is shown in FIG. 20(a). FIG. 21 shows a prior art four node ring network that uses ROADM devices and Type “A” line converters. Each ROADM device in the network is identical, and each ROADM device supports four wavelengths (i.e., K=4 with respect to the ring ROADM pair).

Four bidirectional “wavelength connections” are shown in FIG. 21 namely connections “AB”, “AD”, “BC”, and “CD”. The wavelength connection between a client associated with one node and a client associated with another node is implemented using two dedicated line paths. For instance, the bidirectional wavelength connection between client #1 of node “C” and client #1 of node “B” is implemented via the two paths denoted λ1 in FIG. 21. Two “type A” line converters within each of the two nodes are used to implement the wavelength connection. Also, a single wavelength (λ1) is used in order to implement the wavelength connection. Since this single wavelength is used on all segments of the ring network fiber in order to establish the two bidirectional paths through the network, the wavelength cannot be used to establish any further wavelength connections. With respect to connection “BC”, the information inserted on the interface labeled client #1 (working) at node “C” flows in the clock-wise direction from node “C” to node “B” (using λ1), and exits node “B” via the interface labeled client #1 (protect). Information inserted on the interface labeled client #1 (protect) at node “B” flows in the counter-clock-wise direction from node “B” to node “C” (using λ1), and exits node “C” via the interface labeled client #1 (working). Similarly, information inserted on the interface labeled client #1 (protect) at node “C” flows in the counter-clock-wise direction from node “C” to node “B” (using λ1), and exits node “B” via the interface labeled client #1 (working). Also, information inserted on the interface labeled client #1 (working) at node “B” flows in the clock-wise direction from node “B” to node “C” (using λ1), and exits node “C” via the interface labeled client #1 (protect). From FIG. 21 it can be observed that in support of bidirectional connection “BC”, nodes “A” and “D” must pass-through wavelength λ1.

FIG. 21 shows a total of four protected wavelength connections. Since each wavelength connection requires a dedicated wavelength and four “type A” line converters, a total of four wavelengths and sixteen “type A” line converters are required in order to support the four protected wavelength connections.

FIG. 20(b) illustrates the “type B“ line converter. The ♭type B” line converter combines the line E/O converter shown in FIG. 4 with the line O/E converter shown in FIG. 4 in order to form one bidirectional line converter that is capable of interfacing to an electrical cross-connect via its electrical interfaces.

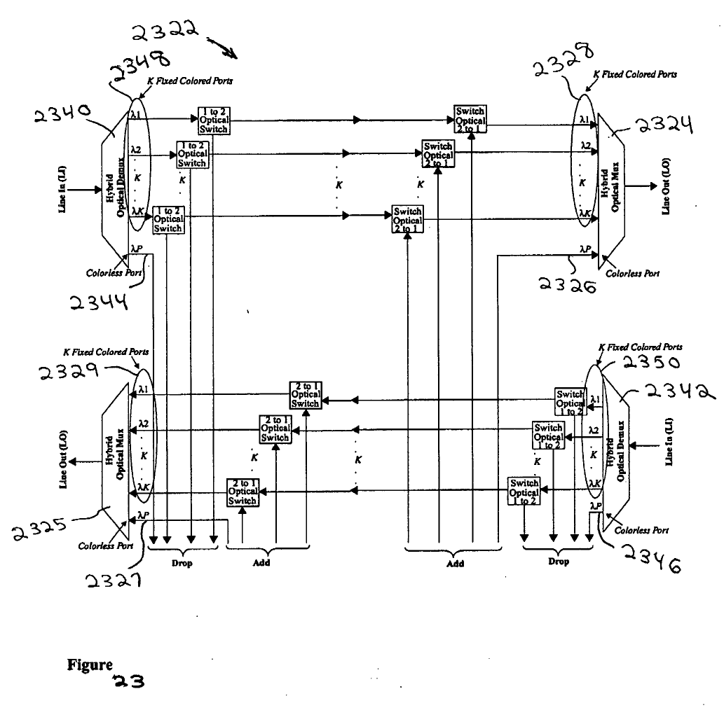

FIG. 22 illustrates a ring application 2200 for the “type B” line converter using ROADM devices. Each node 2220 includes a pair 2222 of ROADM devices 2224 and 2226 that interconnect at add/drop ports 2228 with line converters 2230. The line converters 2230 are joined to a cross-connect 2232 which is joined to client converters 2234. By way of example, the line converters 2230 include a line converter associated with each adjoining node (e.g., node A includes an AB converter and an AD converter) and a protection converter 2236. The ring application 2200 implements four protected wavelength connections in which each node is attached to two other nodes using a pair of fibers. For instance, node “A” is attached to node “B” using two fibers. One fiber is used to send information from node “A” to node “B”, and one fiber is used to send information from node “B” to node “A”. In FIG. 22, the fiber pair between two nodes is illustrated by using a single bidirectional arrow.

The ring application 2200 uses 1 for 1 dedicated line protection. This means if the fiber pair between any two nodes is severed, each wavelength level connection has a alternative path through the ring network. For instance, the two paths for wavelength connection “BC” are shown by lines 2210 and 2212. Although line protection is 1 for 1 for both the ring application shown in FIG. 21 and the ring application 2200 shown in FIG. 22, line converter protection is 1 for N for the ring application 2200 (N=2, in this example), while line converter protection is 1 for 1 in the FIG. 21 application. Both the FIG. 21 and FIG. 22 networks establish the same client-to-client connections, but the FIG. 22 configuration uses a total of only twelve line converters in order to implement four protected wavelength connections, while the FIG. 21 configuration uses a total of 16 line converters.

When a fiber cut failure occurs, the client performs the protection switch at the destination node in the FIG. 21 configuration, while the line converter performs the protection switch at the destination node in the FIG. 22 configuration (via the converter's 2 to 1 optical switch).

When a converter failure occurs, the client performs the protection switch at the destination node in the FIG. 21 configuration, while the ROADMs and cross-connects perform the protection switch in the FIG. 22 configuration.

Next the operation of the ring application 2200 will be discussed during converter failure protection using a fixed colored mux/demux ROADM port. When a ring ROADM pair (e.g., 1806 in FIG. 18) is utilized within each ring node 2200 in the FIG. 22 configuration, then a wavelength is dedicated to the protection line converter 2236. This is because each add/drop port of the ring ROADM pair 2222 is a fixed colored port. In the network of FIG. 22, each protection line converter within each node would operate using the same wavelength (λ5, for instance). This means that the entire network can only be protected against a single line converter failure within the network at any given time. Additional network level line converter protection could only be provided by adding additional protection line converters within each node and by expanding the number of wavelengths (and add/drop ports) within each ROADM device.

In the example of FIG. 22, each ROADM device 2224 and 2226 supports K=5 wavelengths and K=5 add/drop ports. Thus, when a line converter 2230 fails, the cross-connect devices 2232 within each node 2220 are used to reroute signals in the same fashion that signals were rerouted in the line converter failures described above in connection with FIG. 8 and FIG. 11. For instance, when the “CD” line converter of node “C” fails in the network of FIG. 22, the cross-connect devices 2232 within nodes “C” and “D” are re-configured in order to reroute the “CD” wavelength connection client signals to and from the protection converter 2236. The “CD” wavelength connection is then routed via the WDM line network using the protection wavelength (wavelength λ5), instead of wavelength λ2. The new paths are denoted by lines 2240 and 2242.

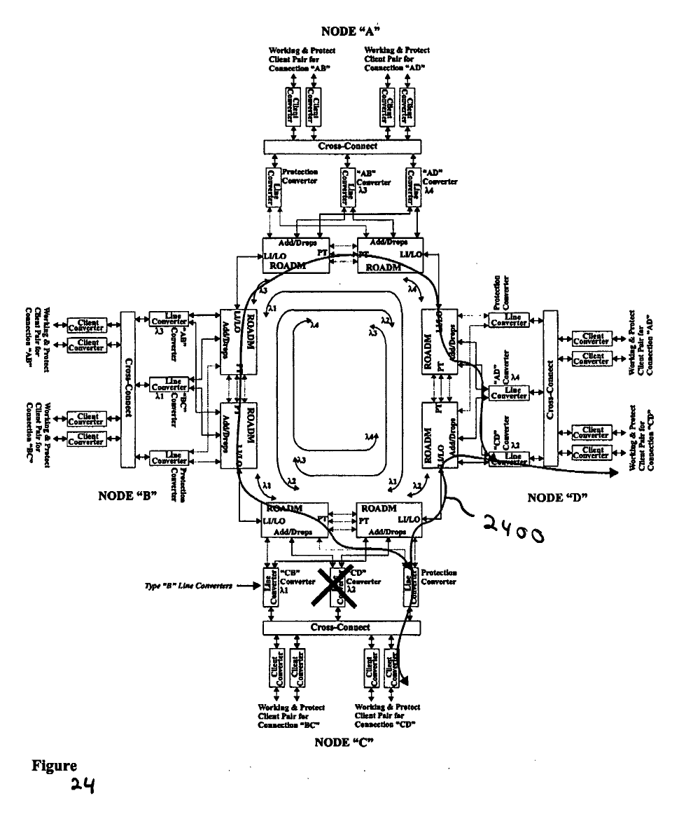

FIG. 23 illustrates a block diagram of a ring ROADM pair 2322 formed in accordance with one embodiment. The ring ROADM pair 2322 utilizes multiplexers 2324 and 2325 each of which has a colorless add port 2326 and 2327, respectively, and K fixed colored add ports 2328 and 2329, respectively. Demultiplexers 2340 and 2342, each have a single colorless drop port 2344 and 2346, and K fixed colored drop ports 2348 and 2350, respectively. The colorless add ports 2326 and 2327 are each used in conjunction with a protection line converter containing a tunable optical transmitter such that dedicated protection wavelengths are not required. The ring ROADM pair 2322 supports K wavelengths. The hybrid optical mux 2324 and 2325 can be constructed as shown in FIG. 15, and the hybrid optical demux 2340 and 2342 can be constructed as shown in FIG. 16.

Optionally, each of the ring ROADM pairs 2222 in FIG. 22 may be replaced with the ring ROADM pair 2322 shown in FIG. 23, and each of the protection converters may be a “type B” converter with a tunable optical transmitter. When a given line converter fails, the failure can be protected such that an additional dedicated protection wavelength is not required. In the node where the line converter fails, the cross-connect within the node redirects the client signals associated with the failed converter to the protection line converter. The optical transmitter within the protection converter is then retuned to the wavelength of the failed converter, and the ring ROADM pair within the node with the failure is re-configured such that the optical output of the protection converter is directed to each of the two WDM line output interfaces and the wavelength associated with the failed converter is directed from the WDM line input interfaces to the protection converter. Since the protection converter uses the same wavelength as the failed converter, no action is required to be taken within the node at the opposite side of the wavelength connection.

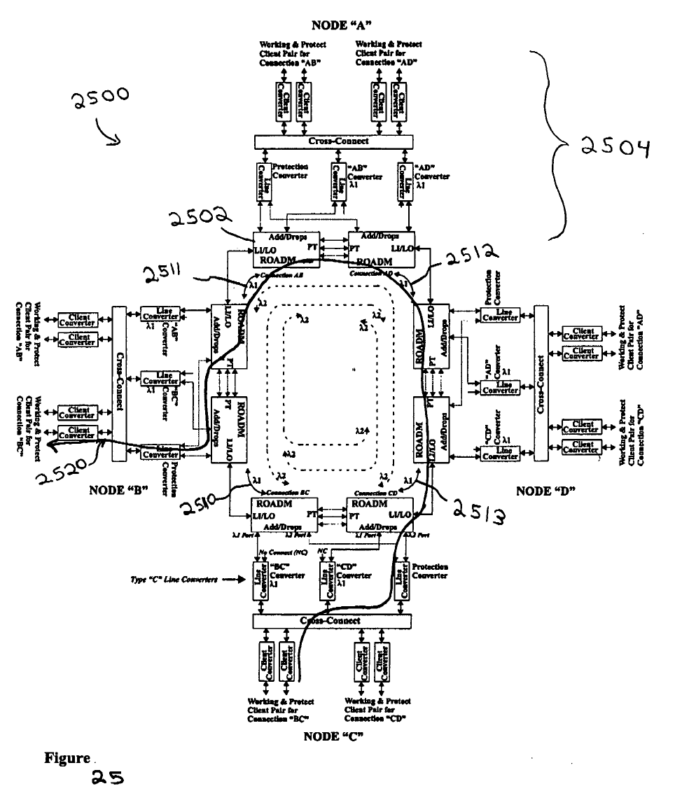

Assuming that each ROADM pair 2222 within FIG. 22 network supports K=4 wavelengths, K=4 fixed colored add/drop ports, and one colorless add/drop port, when a given line converter fails, the cross-connect devices within each node are used to reroute signals in the same fashion that signals were rerouted in the line converter failures depicted in FIG. 9 and FIG. 12. For instance, assume that the “CD” line converter of node “C” fails in FIG. 22. The cross-connect devices within node “C” are re-configured in order to reroute the “CD” wavelength connection client signals to and from the protection line converter. The “CD” wavelength connection is then routed via the WDM line network using same wavelength as used by the failed converter (i.e., wavelength 2). The new path 2400 is shown in FIG. 24.

Although only a single protection line converter within a given node has been discussed, additional protection converters (each one attached to a colorless ROADM port) can be used to increase the protection capabilities within a given node.

FIG. 20c illustrates a “type C” line converter. The “type C” line converter is similar to the “type B” line converter but contains a 1 to 2 optical switch instead of a 1 to 2 optical coupler. The “type C” line converter allows wavelengths to be reused where possible.

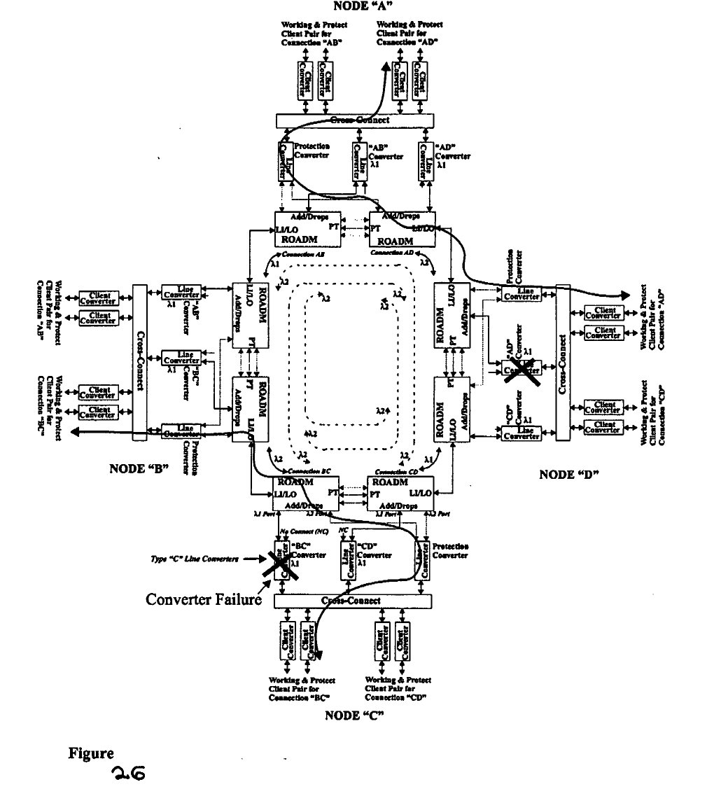

FIG. 25 illustrates a ring application 2500 that utilizes the “type C” line converter using ROADM devices 2502. The ring application 2500 implements four protected wavelength connections. Each node is attached to two other nodes using a pair of fibers. For instance, node “A” is attached to node “B” using two fibers. One fiber is used to send information from node “A” to node “B”, and one fiber is used to send information from node “B” to node “A”. The fiber pair between two nodes is illustrated by using a single bidirectional arrow.

From FIG. 25 it can be seen that all four wavelength connections are established by using a single wavelength (λ1), and all four wavelength connections are protected using a single protection wavelength (λ2). This is possible due to the 1 to 2 optical switch within the “type C” line converter. For example, for wavelength connection “BC”, the “BC” converter in node “C” uses λ1 to direct its client associated signals to converter “BC” in node “B” via the left ROADM within node “C” in FIG. 25, and for wavelength connection “CD”, the “CD” converter in node “C” uses λ1 to direct its client associated signals to converter “CD” in node “D” via the right ROADM within node “C” in FIG. 25. For the case where there are no network failures, λ1 is not “passed through” the two ROADM devices within any node. The four wavelength connections 2510-2513 are illustrated with four arrows in FIG. 25.

As can be seen in FIG. 25, only the protection converter is physically attached to both of the two ROADMs 2502 within a given node 2504. Only two add/drop ports are required on each ROADM 2502, and both of these add/drop ports may be fixed colored add/drop ports. In addition, each ROADM 2502 needs to only support two wavelengths (λ1 and λ2). None of the line converters (including the protection converter) require tunable optical transmitters. Under normal operating conditions, the optical output transmitters within all protection converters are turned off. When either a fiber cut occurs or a line converter fails, the protection converter and its associated dedicated protection wavelength (λ2) is used to protect against the failure. For example, assume that the fiber pair between nodes “B” and “C” is cut. In order to protect against this failure, the client signals associated with wavelength connection “BC” in both nodes “B” and “C” are redirected to the protection converter via the cross-connects. The optical transmitters in the protection converters in nodes “B” and “C” are turned on, and the 1 to 2 switches within the two protection converters are set such that their signals are directed to the ROADM with the non-cut line fiber. The λ2 signal path illustrated by the dotted line in FIG. 25 is then used to transport the “BC” wavelength connection. The complete path is shown at 2520 in FIG. 25.

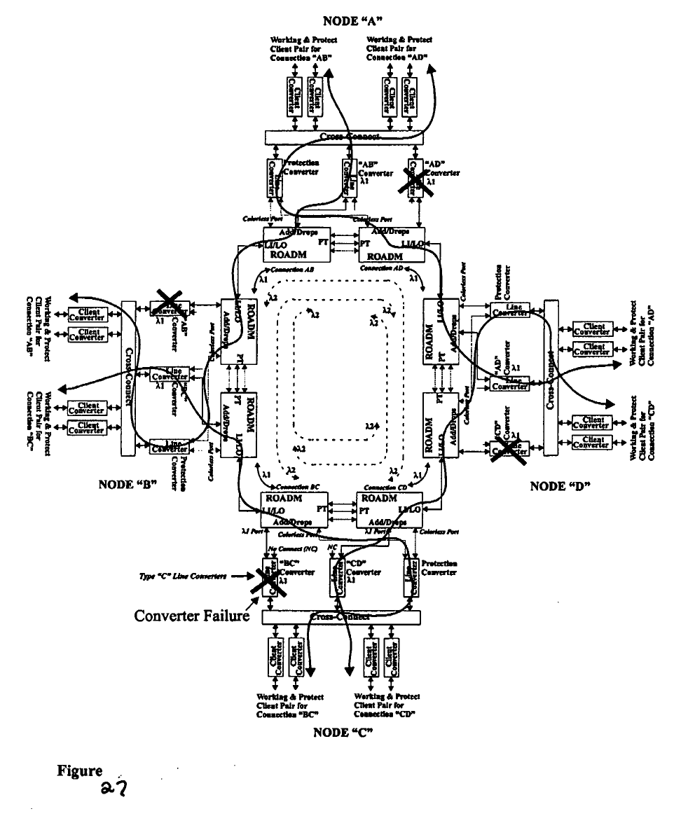

When a line converter fails in the FIG. 25, the protection converter is used both in the node where the converter failed and in the other node associated with the wavelength connection. However, the protection line converters within both nodes direct their optical switches (in both the transmit and receive directions) to the line interface associated with the original wavelength connection. This allows multiple line converter failures within the network to be protected, as shown in FIG. 26. In FIG. 26, when the “BC” line converter fails in node “C”, and the “AD” line converter fails in node “D”, both connections are reestablished using λ2 and the protection line converters in each node.

It can be seen that the network shown in FIG. 25 supports the same four protected client-to-client connections as the networks shown in FIGS. 21 and 22, but the network shown in FIG. 25 only requires 12 line converters and uses only two wavelengths.

If in the FIG. 25 configuration each ROADM 2500 is equipped with one fixed colored add/drop port and one colorless add/drop port, and the protection converter contains a tunable optical transmitter and is connected to the colorless add/drop port of each ROADM device within a node, then some additional protection capabilities are provided.

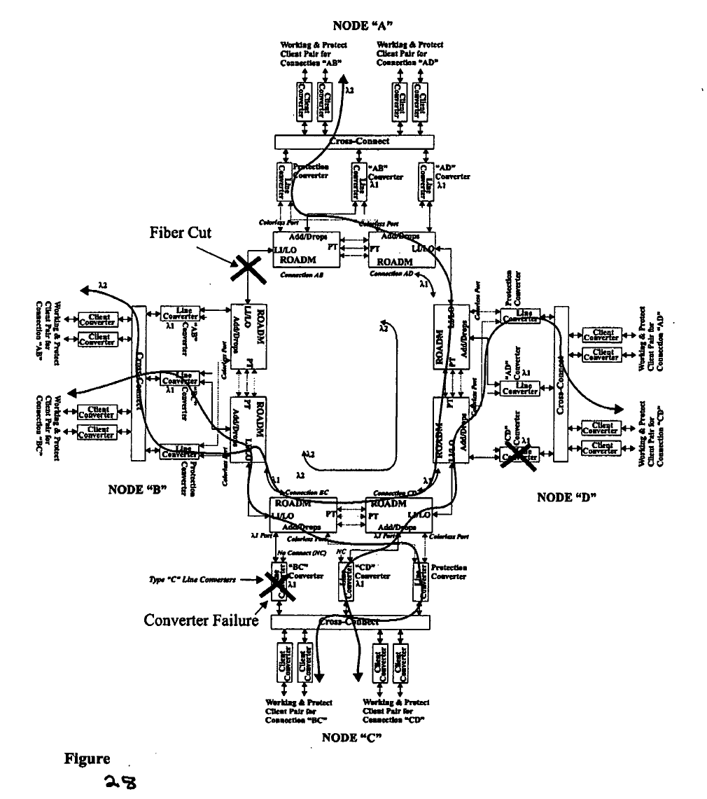

For the case of a single fiber cut, protection recovery is identical to the previously discussed fiber cut scenario shown in FIG. 25. Once again, only a single fiber (pair) cut can be protected. However, now when a converter fails, only the node with the failed converter has to utilize its protection converter. The node with the failed converter can tune its protection converter to the wavelength of the failed converter and then direct this wavelength to the same line interface of the failed converter. Therefore, the node at the opposite end of the wavelength connection requires no action. This provides protection against a converter failure within each node, as shown in FIG. 27, or protection against a combination of multiple converter failures and a single fiber cut, as shown in FIG. 28.

Since the line interfaces are separated from the client interfaces, the optical client interfaces can be replaced with protected or unprotected electrical client interfaces with no loss of functionality. Similarly, unprotected client interfaces can be supported with protected line interfaces. Client protection is handled separately from line protection via the use of the cross-connects.

While the invention has been described in terms of various specific embodiments, those skilled in the art will recognize that the invention can be practiced with modification within the spirit and scope of the claims.

What is claimed is:

1. An optical communications device, comprising:
input lines configured to receive client signals;
multiple electrical to optical (E/O) line converters converting the client signals into associated optical line signals;
a routing element connecting the client signals to the E/O converters;
a line optical interface used to transmit optical line signals; and
a protection E/O line converter configured to replace a selected one of at least two of the multiple E/O line converters.

2. The optical communications device of claim 1, wherein all of the E/O line converters are protected with a single protection E/O line converter.

3. The optical communications device of claim 1, further comprising a group of N primary said E/O line converters and a group of P protection line converters that form a P-for-N line converter protection group, where N equals a total number of client signals and P differs from N.

4. The optical communications device of claim 1, wherein the client signals are configured as working and protect client signals with each working client signal having an associated protect client signal.

5. The optical communications device of claim 1, wherein the routing element includes one of an electrical cross-connect and a series of multiplexers.

6. The optical communications device of claim 1, wherein the E/O line converters, routing element and protect E/O line converter form a node joined in a ring application to other nodes.

7. The optical communications device of claim 1, wherein the routing elements reroute a client signal to the protection E/O line converter when an associated one of the multiple E/O line converters fails.

8. The optical communications device of claim 1, wherein the protection E/O line converter transmits an optical line signal using a predetermined wavelength dedicated to protection transmissions.

9. The optical communications device of claim 1, wherein the protection E/O line converter is tunable to transmit an optical line signal using a variety of wavelengths not dedicated to protection transmissions.

10. The optical communications device of claim 1, further comprising optical multiplexers having one of fixed colored ports and colorless ports coupled to the E/O line converters.

11. The optical communications device of claim 1, wherein the protection E/O line converter is tunable to a wavelength of a failed E/O line converter.

12. The optical communications device of claim 1, further comprising a client interface unit provided at the input lines, the routing element separating the client interface unit from the line optical interface.

13. The optical communications device of claim 1, further comprising an optical directivity element connected to a line receiver of one of the E/O line converters, the optical directivity element being a two-to-one optical switch.

14. The optical communications device of claim 1, further comprising an optical directivity element connected to a line transmitter of one of the E/O line converters, the optical directivity element being one of a one-to-two optical switch and a one-to-two optical coupler.

15. The optical communications device of claim 1, wherein a redundant optical line signal is transmitted from the E/O line converters to each of two optical multiplexers using a one-to-two optical coupler type optical directivity element.

16. The optical communications device of claim 1, wherein the optical line signal from one of the E/O line converters is transmitted to a single selected optical multiplexer using a one-to-two optical switch type optical directivity element.

17. The optical communications device of claim 1, wherein a two-to-one optical switch type optical directivity element is used to select one of two optical line signals received from two optical demultiplexers.

18. The optical communications device of claim 1, wherein the routing element selects and forwards one of two received redundant signals.

19. The optical communications device of claim 1, further comprising primary said E/O line converters forwarding signals to fixed colored ports of the optical multiplexers and protection line converters forwarding signals to colorless ports of the optical multiplexers.

20. An optical communications system, comprising:
a first terminal receiving client signals, the first terminal including a P-for-N line protection group converting and rerouting the client signals into WDM signals, wherein N equals a total number of client signals received by the first terminal and P does not equal N;
a second terminal; and
optical communications paths configured to convey the WDM signals from the first terminal to the second terminal.

21. The optical communications system of claim 20, wherein the client signals include working and protect client signals, N equaling the total number of working client signals.

22. The optical communications system of claim 20, wherein the client signals include unprotected client signals.

23. The optical communications system of claim 20, wherein the P-for-N line protection group includes N optical to electrical (O/E) client converters and N electrical to optical (E/O) line converters associated in a one to one relationship with the N client signals.

24. The optical communications system of claim 20, wherein the first terminal includes a tunable protection E/O line converter that changes wavelength when a primary E/O line converter fails and an optical multiplexer with a colorless input port.

25. The optical communications system of claim 20, wherein the P-for-N line protection group includes N electrical to optical (E/O) line converters, further comprising cross-connect inter-connecting information within the client signals to the E/O line converters.

26. The optical communications system of claim 20, wherein the P-for-N line protection group includes N electrical to optical (E/O) line converters, further comprising optical multiplexers outputting the WDM working line optical signal based on outputs of the N E/O line converters.

27. The optical communications system of claim 20, wherein the first terminal includes at least one of an optical multiplexer utilizing a colorless input port and an optical demultiplexer utilizing a colorless output port.

28. A method for protecting optical signals within a wavelength division multiplexed (WDM) environment, comprising:
providing client signals;
routing the client signals through a P-for-N line protection group, where N equals the number of client signals and P does not equal N;
converting the client signals to colored optical line signals;
multiplexing the colored optical line signals to produce WDM optical signals; and
detecting failures within the WDM environment, wherein routing includes rerouting multiple client signals through a common protection electrical to optical (E/O) converter in the P-for-N line protection group based upon failure detection.

29. The method of claim 28, wherein the P-for-N line protection group includes N E/O line converters that are all protected only with the common protection E/O line converter.

30. The method of claim 28 wherein the client signals are configured as working and protect client signals with each working client signal having an associated protect client signal.

31. The method of claim 28, further comprising dividing each optical signal into at least two optical signals.

32. The method of claim 28, wherein the common protection E/O converter transmits over a predetermined wavelength dedicated to protection transmissions.

33. The method of claim 28, wherein the common protection E/O line converter is tunable to transmit over a variety of wavelengths not dedicated to protection transmissions.

34. The method of claim 28, further comprising providing primary line converters and organizing the primary line converters into protection groups, wherein the primary line converters in a protection group are uniquely associated with specific client signals, each protection group having only one protection line converter to protect multiple primary line converters.

35. The method of claim 28, further comprising:
providing primary line converters in the P-for-N line protection group;
upon detecting failure of a primary line converter, forwarding a wavelength associated with the protection converter to the client signal associated with the failed primary line converter.

36. The method of claim 28, further comprising:
providing primary line converters in the P-for-N line protection group;
upon detecting failure of a primary line converter, tuning the protection converter to the same wavelength as the failed primary line converter.

37. The method of claim 28, further comprising providing one of a point-to-point WDM link and a ring configuration.

38. The method of claim 28, wherein the converting utilizes Type C line converters.

39. An optical communication system, comprising:
a first terminal with multiple client input interfaces receiving input client signals, the first terminal including multiple primary electrical to optical (E/O) line converters and a protection E/O line converter, said primary and protection E/O line converters converting electrical signals to colored optical line signals;
a routing element directing and redirecting signals from the client input interfaces to the E/O line converters;
optical directivity elements connected to an output of each of the E/O line converters, the optical directivity elements directing each colored optical line signal to at least two optical multiplexing units, the at least two optical multiplexing units each being used to multiplex the colored optical line signals output from the optical directivity elements into a wavelength division multiplexed (WDM) optical signal;
a second terminal receiving at least two WDM optical signals, the second terminal including:
at least two optical de-multiplexing units each used to de-multiplex the associated received WDM optical signal into multiple colored optical line signals;
multiple primary optical to electrical (O/E) line converters and a protection O/E line converter used to convert colored optical line signals to electrical signals;
optical directivity elements connecting an input of each O/E line converter to an output of each optical de-multiplexer unit, the optical directivity elements being used to select one colored optical line signal from the optical de-multiplexers;
multiple client output interfaces; and
a routing element used to direct and redirect output client signals from the O/E line converters to the client output interfaces; and
at least two optical communication fibers configured to convey the wavelength division multiplexed optical signals from the first terminal to the second terminal.

40. The optical communications system of claim 39, wherein the protection E/O line converter transmits over a predetermined wavelength dedicated to protection transmissions and through an optical directivity element that is attached to a fixed colored input port of the optical multiplexers, and wherein the protection O/E line converter receives a predetermined wavelength dedicated to protection transmissions through an optical directivity element that is attached to a fixed colored output port of the optical de-multiplexers.

41. The optical communications system of claim 39, wherein the protection E/O line converter is tunable to transmit over a wide variety of wavelengths not dedicated to protection transmissions and through an optical directivity element that is attached to a colorless input port of the optical multiplexers, and wherein the protection O/E line converter is able to receive a wide variety of wavelengths not dedicated to protection transmissions through an optical directivity element that is attached to a colorless output port of the optical de-multiplexers.

42. The optical communications system of claim 39, wherein in the event of the failure of one of a primary E/O line converter and a primary O/E line converter, the routing element within the first terminal redirects the input client signal associated with the failed converter to the protection E/O line converter, and the optical de-multiplexer within the second terminal directs the predetermined wavelength dedicated to protection transmissions to the protection O/E line converter, and the routing element within the second terminal routes the output client signal from the protection O/E line converter to the output client signal associated with failed line converter.

43. The optical communications system of claim 39, wherein, in the event of the failure of a primary E/O line converter, the routing element within the first terminal redirects the input client signal associated with the failed converter to the protection E/O line converter, and the protection E/O line converter transmits the input client signal over the wavelength utilized by the failed primary E/O line converter.

44. The optical communications system of claim 39, wherein, in the event of the failure of a primary O/E line converter, the optical de-multiplexer within the second terminal re-directs the colored optical line signal associated with the failed converter to the protection O/E line converter, and the routing element within the second terminal routes the output signal from the protection O/E line converter to the output client signal associated with failed O/E line converter.

45. The optical communications system of claim 39, wherein in the event of the failure of one of the at least two optical communication fibers, the optical directivity elements within the first terminal direct the signals from the E/O line converters to the fiber without the failure, and the optical directivity elements within the second terminal select the signals from the fiber without the failure.

46. The optical communications system of claim 39, wherein in the event of the failure of one of an optical multiplexer and optical de-multiplexer associated with a first optical communication fiber, the optical directivity elements within the first terminal direct the signals from the E/O line converters to a second optical communication fiber, and the optical directivity elements within the second terminal select the signals from the second optical communication fiber.

47. The optical communications system of claim 39, wherein in the event of the failure of the colored optical line signal between an E/O line converter and an optical multiplexer associated with a first optical communication fiber, the associated optical directivity element within the first terminal directs the signal from the E/O line converter to a second optical communication fiber, and the associated optical directivity element within the second terminal selects a signal from the second optical communication fiber.
